(19) United States
(12) Patent Application Publication
(10) Pub. No.: US 2022/0041441 A1
(43) Pub. Date: Feb. 10, 2022

(54) BI-REFORMING OF HYDROCARBONS TO PRODUCE SYNTHESIS GAS

(71) Applicant: SABIC GLOBAL TECHNOLOGIES B.V., Bergen op Zoom (NL)

(72) Inventors: Lawrence D'SOUZA, Thuwal (SA); Shabbir Taherbhai LAKDAWALA, Jubail (SA); Ahmed E. HADHRAMI-AL, Thuwal (SA); Ibrahim Khaled AL-HOWAISH, Thuwal (SA)

(73) Assignee: SABIC GLOBAL TECHNOLOGIES B.V., Bergen op Zoom (NL)

(21) Appl. No.: 17/275,271

(22) PCT Filed: Sep. 5, 2019
(86) PCT No.: PCT/IB2019/057500

§ 371 Date: Mar. 11, 2021

Related U.S. Application Data
(60) Provisional application No. 62/730,294, filed on Sep. 12, 2018.

(51) Int. Cl. C01B 3/40; B01J 21/04; B01J 23/02; B01J 23/10; B01J 23/847; B01J 23/825; B01J 23/83; B01J 23/89; C21B 13/00

(52) U.S. Cl. CPC C01B 3/40; C01B 2203/06; B01J 23/02; B01J 23/10; B01J 23/8474; B01J 23/825; B01J 23/83; B01J 23/898; B01J 23/8973; B01J 23/896; B01J 23/894; B01J 23/892; C21B 13/0073; C01B 2203/0238; C01B 2203/0233; C01B 2203/1241; C01B 2203/1082; C01B 2203/1094; C01B 2203/1058; B01J 21/04

(57) ABSTRACT

Disclosed are catalysts, methods, and systems for the bi-reforming of hydrocarbons. The method includes contacting a catalyst material with a reactant feed that includes hydrogen (H₂), carbon monoxide (CO), carbon dioxide (CO₂), methane (CH₄), and water (H₂O) to produce a product stream that has a H₂/CO molar ratio of 1.4:1 to 2:1. The catalyst can have a metal oxide core, a redox metal oxide layer deposited on a surface of the metal oxide core, and a catalytically active metal deposited on the surface of the redox metal oxide layer. A dopant can be included in the redox metal oxide layer. The catalyst can have a corm-shell type structure.

### CROSS REFERENCE TO RELATED APPLICATIONS

This application claims the benefit of priority to U.S. Provisional Patent Application No. 62/730,294 filed Sep. 12, 2018, the entire contents of which are hereby incorporated by reference in their entirety.

### BACKGROUND OF THE INVENTION

### A. Field of the Invention

The invention generally concerns the bi-reforming of hydrocarbons (e.g., methane) using a catalyst having a core-shell structure with an active metal deposited on the surface of the shell. The shell has a redox-metal oxide phase that includes a metal dopant.

### B. Description of Related Art

The iron and steel industry uses synthesis gas (“syngas”) with a hydrogen to carbon monoxide (H₂/CO) ratio of 1.6 to 2.0, or 1.85, for reducing iron ore to iron metal. The H₂/CO ratio can influence the properties related to reduced iron ore transportation or further processing (e.g., flow properties, physical properties and morphological properties). MIDREX® Technologies, U.S.A. and HYL Technologies (Mexico) are two main technology providers for this process. The MIDREX® reformer uses bi-reforming of methane, which is a combination of dry reforming of methane and steam reforming of methane, to produce a product feed having the desired H₂/CO ratio. Bi-reforming of methane is shown in reaction equation (1).

3CH₄+CO₂+2H₂O+↔4CO+8H₂ ΔH_{298K}=220 kJ/mol; ΔH_{298K}=151 kJ/mol (1).

Feed streams for a bi-reformer can include controlled amounts of H₂, CO₂, and H₂O to produce a desired H₂/CO ratio. By way examples, a feed stream can have a composition of 14 to 16 vol. % CO, 12 to 14 vol. % CO₂, 32 to 36 vol. % H₂, 16.5 to 19.5 vol % H₂O, 14 to 18 vol. % CH₄, and 3.5 to 4.5 vol. % N₂. Processing this composition with a catalyst at 850 to 900° C. at 0.1 MPa can produce a product stream has a composition of 30 to 32 vol. % CO, 2 to 3 vol. % CO₂, 55 to 57 vol. % H₂, 7 to 8 vol % H₂O, 0.3 to 0.1 vol. % CH₄, and 2.2 to 3.2 vol. % N₂. Due to various uncontrollable events and the natural state of the catalyst in use, carbon invariably deposits over the catalyst, which gradually causes an increase in reformer pressure drop. As the process gas flow is limited, productivity is reduced. Furthermore, under low flow rates damage to the reformer (e.g., mechanical and thermal integrity) can occur.

While many catalysts are available for dry reforming of methane using CO₂ and/or CO₂ and oxygen (O₂) (oxy-CO₂ reforming) (See, for example, WO2017001987 to D'Souza et al.), direct application of these catalysts to bi-reforming of methane is not predictable. As discussed in an overview of bi-reforming of methane, Kumar et al. (Current Opinion in Chemical Engineering, 2015, 9:8-15) explains that the bi-reforming process is a more oxygen-rich system as compared to dry reforming or oxy-CO₂ reforming. Thus, the catalyst is more vulnerable to oxidation. Oxidation of the catalyst can lead to deactivation of the catalyst with time on stream due to the loss of active sites. Therefore, the feed ratio and catalyst selection can be limiting conditions for achieving a higher H₂/CO ratio from the bi-reforming reaction.

While catalysts are known for bi-reforming of methane reactions, these suffer from deactivation due to coking and/or oxidation. Thus, there is a need for catalysts that can withstand conditions that promote both oxidation and/or carbon deposition.

### SUMMARY OF THE INVENTION

A solution to at least some of the problems associated with the costs, deactivation, and/or degradation of catalysts during bi-reforming reactions has been discovered. It was unexpectedly found that catalysts having a particular core-shell structure had high catalytic activity and good resistance to oxidation, coking, and sintering in bi-reforming of methane reactions. The core-shell structure can include a chemically inert core surrounded by a shell with an active/catalytic metal deposited on the surface of the shell. The shell can have a redox-metal oxide phase (e.g., a cerium dioxide (CeO₂) phase) that includes a metal dopant (e.g., Nb, In, Ga, and/or La). The dopant can be incorporated into the lattice framework of the redox-metal oxide phase. Without wishing to be bound by theory, it is believed that this structural set-up provides a number of advantages in the bi-reforming of methane reaction. For example, the core-shell structure can provide for increased mechanical strength, thermal integrity, and decreased production costs of the catalyst. Also, doping of the redox-metal oxide phase of the shell is believed to create a relatively high concentration of defects in its lattice structure, thereby allowing for improved oxygen mobility and increased oxygen vacancies in the lattice structure. This, in turn, increases the phase's reducibility and favors a continuous removal of carbon deposits from its active sites. Further, the oxygen mobility feature can be tunable by varying the thickness of the shell layer (e.g., shell layer thickness can be modified to be 1 atomic layer to 100 atomic multilayers). It is also believed that the alkaline earth aluminate (e.g., MgAl₂O₄) core has high affinity towards CO₂, which can adsorb more carbon dioxide and helps to oxidize carbon formed on the catalyst as shown in following equation: C+CO₂→2 CO. This combination of features results in bi-reforming of methane catalysts that (1) are economically viable to produce, (2) have sufficient mechanical strength, (3) are highly active, and/or (4) are resistant to oxidation, coking and sintering (thermal integrity).

In some aspects, methods for producing synthesis gas from methane are described. The method can include contacting a reactant gas stream that includes hydrogen (H₂), carbon monoxide (CO), carbon dioxide (CO₂), methane (CH₄), and water (H₂O) with a catalyst material of the present invention under conditions sufficient to produce a gaseous product stream comprising H₂ and CO in a H₂/CO molar ratio of 1.4 to 2.0, preferably 1.6 to 2.0, more preferably about 1.85. The reactant stream can include 25 vol. % to 40 vol. % H₂, 5 vol. % to 30 vol. % CO, 5 vol. % to 20 vol. % CO₂, 10 vol. % to 30 vol. % CH₄, and 10 vol. % to 30 vol. % H₂O, preferably 30 vol. % to 35 vol. % H₂, 10 vol. % to 20 vol. % CO, 10 vol. % to 15 vol. % CO₂, 15 vol. % to 20 vol. % CH₄, and 15 vol. % to 20 vol. % H₂O. The reaction conditions can include a temperature of 700° C. to 1000° C., a pressure of about 0.1 MPa to 2 MPa, a gas hourly space velocity of 500 h⁻¹ to 100,000 h⁻¹, or any combination thereof. The reaction conditions can include contacting the catalyst at a temperature of at least 550° C. with a CO₂ stream comprising at least 50 vol. % CO₂ for at least 6 hours prior to contacting the catalyst with the gaseous reactant stream. A portion of CO₂ in the CO₂ stream can be replaced with CH₄, H₂O, CO, and H₂ to produce the gaseous reactant stream. Replacing the CO₂ can include (a) introducing CH₄ to the CO₂ stream and contacting the heated catalyst with the CO₂/CH₄ stream at a temperature of at least 600° C. for at least 1 hour, (b) increasing the concentration of CH₄ in the CO₂/CH₄ stream relative to the amount of CO₂ over time to produce a CO₂/CH₄ stream comprising about equal amounts of CO₂ and CH₄, (c) introducing H₂O to the CO₂/CH₄ stream at temperature of at least 700° C. to form a CO₂/CH₄/H₂O stream, and (d) introducing CO and H₂ to the CO₂/CH₄/H₂O stream, forming the gaseous reactant stream comprising H₂, CO, CO₂, CH₄, and H₂O at a temperature of at least 700° C. Step (b) can include increasing the temperature from 600° C. to at least 700° C. at a rate of about 5 to 10° C. per hour. Notably, during the production of syngas, coke formation on the catalyst can be substantially or completely inhibited. The pressure can remain constant for at least 600 hours, or at least 1200 hours, during the production of syngas. The product stream can be provided to a direct reduced iron unit and be used to reduce iron oxide to iron.

The catalyst material can include a chemically inactive metal oxide core, a redox metal oxide layer deposited on a surface of the metal oxide core, the redox metal oxide layer comprising a dopant, and a catalytically active metal deposited on the surface of the redox metal oxide layer. The metal oxide layer and alkaline earth metal aluminate core can be a core/shell structure where the redox-metal oxide layer surrounds the alumina or alkaline earth metal aluminate core. The chemically inactive metal oxide core can be alumina or magnesium aluminate, the redox-metal oxide layer can be cerium oxide (CeO₂), the metal dopant can be niobium (Nb), indium (In), or lanthanum (La), or any combination thereof, and the active metal can be nickel. The alkaline earth metal aluminate core can be magnesium aluminate, calcium aluminate, strontium aluminate, barium aluminate, or any combination thereof. The alkaline earth metal aluminate core can be magnesium aluminate, the redox-metal oxide layer can be a cerium oxide layer, the metal dopant can niobium (Nb), indium (In), lanthanum (La), or gallium (Ga), or any combination thereof, and the active metal can be nickel (Ni). In some embodiments, the catalyst can include 65 wt. % to 85 wt. % alumina or magnesium aluminate, 10 wt. % to 20 wt. % cerium oxide, and 5 wt. % to 10 wt. % nickel. In certain instances, 0.5 wt. % to 2 wt. % of niobium or indium can be incorporated into the lattice framework of the cerium oxide layer. The redox-metal oxide layer of the catalyst of the present invention for the production of synthesis gas through bi-reforming of methane can have a thickness of 1 nanometer (nm) to 500 nm, preferably 1 nm to 100 nm, or more preferably 1 nm to 10 nm.

In some embodiments, a system for direct reduction of iron ore is described. A system can include a reforming unit capable of producing synthesis gas that includes hydrogen (H₂) and carbon monoxide (CO) in a H₂/CO molar ratio of 1.6 to 2.0 from a gaseous reactant stream comprising H₂, CO, carbon dioxide (CO₂), methane (CH₄), and water (H₂O). The reforming unit can include a reaction zone that includes the gaseous reactant feed and a catalyst material. The catalyst material can include a chemically inactive metal oxide core, a redox metal oxide layer deposited on a surface of the metal oxide core, the redox metal oxide layer comprising a dopant, and a catalytically active metal deposited on the surface of the redox metal oxide layer, and a furnace in fluid communication with the reformer, the furnace capable of reducing iron ore using the synthesis gas received from the reformer.

The following includes definitions of various terms and phrases used throughout this specification.

The terms “oxygen mobility” refers to the ease at which an oxygen ion (O⁻) is removed from a metal oxide and is related to the crystal defects in the metal oxide crystal lattice. In the case of CeO₂₋ₓ, x denotes the removable oxygen or mobile oxygen available for a redox reaction.

The term “catalyst” means a substance which alters the rate of a chemical reaction. “Catalytic” means having the properties of a catalyst.

The term “dopant” or “doping agent” is an impurity added to or incorporated within a catalyst to optimize catalytic performance (e.g., increase or decrease catalytic activity). As compared to the undoped catalyst, a doped catalyst may increase or decrease the selectivity, conversion, and/or yield of a reaction catalyzed by the catalyst. Doped and promoted are used interchangeably throughout the disclosure.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The catalysts, methods, and systems of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the catalysts, methods and systems of the present invention are their abilities to bi-reform methane to produce syngas having a H₂/CO ratio of 1.4 to 2.0, preferably about 1.85, which is suitable for use in the direct reduction of iron.

In the context of the present invention, at least twenty embodiments are now described. Embodiment 1 is a method of producing synthesis gas from methane. The method includes the steps of contacting a reactant gas stream that includes hydrogen (H₂), carbon monoxide (CO), carbon dioxide (CO₂), methane (CH₄), and water (H₂O) with a catalyst material under conditions sufficient to produce a gaseous product stream that contains H₂ and CO in a H₂/CO molar ratio of 1.4 to 2.0. The catalyst material contains a chemically inactive metal oxide core; a redox metal oxide layer deposited on a surface of the metal oxide core, the redox metal oxide layer contains a dopant; and a catalytically active metal deposited on the surface of the redox metal oxide layer. Embodiment 2 is the method of embodiment 1, wherein the reaction conditions include a temperature of 700° C. to 1000° C., a pressure of about 0.1 MPa to 2 MPa, and a gas hourly space velocity of 500 h⁻¹ to 100,000 h⁻¹. Embodiment 3 is the method of any one of embodiments 1 to 2, wherein the reactant stream contains 25 vol. % to 40 vol. % H₂, 5 vol. % to 30 vol. % CO, 5 vol. % to 20 vol. % CO₂, 10 vol. % to 30 vol. % CH₄, and 10 vol. % to 30 vol. % H₂O. Embodiment 4 is the method of embodiment 3, wherein the reactant stream contains 30 vol. % to 35 vol. % H₂, 10 vol. % to 20 vol. % CO, 10 vol. % to 15 vol. % CO₂, 15 vol. % to 20 vol. % CH₄, and 15 vol. % to 20 vol. % H₂O. Embodiment 5 is the method of any one of embodiments 1 to 4, wherein the H₂/CO molar ratio is 1.6 to 2.0, preferably 1.85. Embodiment 6 is the method of any one of embodiments 1 to 5, wherein the conditions include contacting the catalyst at a temperature of at least 550° C. with a CO₂ stream contains at least 50 vol. % CO₂ for at least 6 hours prior to contacting the catalyst with the gaseous reactant stream. Embodiment 7 is the method of embodiment 6, further including the step of replacing a portion of the CO₂ in the CO₂ stream with CH₄, H₂O, CO, and H₂ to produce the gaseous reactant stream. Embodiment 8 is the method of embodiment 7, wherein replacing a portion of the CO₂ in the CO₂ stream includes the steps of introducing CH₄ to the CO₂ stream and contacting the heated catalyst with the CO₂/CH₄ stream at a temperature of at least 600° C. for at least 1 hour; increasing the concentration of CH₄ in the CO₂/CH₄ stream relative to the amount of CO₂ over time to produce a CO₂/CH₄ stream containing about equal amounts of CO₂ and CH₄; introducing H₂O to the CO₂/CH₄ stream at temperature of at least 700° C. to form a CO₂/CH₄/H₂O stream; and introducing CO and H₂ to the CO₂/CH₄/H₂O stream, forming the gaseous reactant stream containing H₂, CO, CO₂, CH₄, and H₂O at a temperature of at least 700° C. Embodiment 9 is the method of embodiment 8, wherein step (b) further includes the step of increasing the temperature from 600° C. to at least 700° C. at a rate of about 5 to 10° C. per hour. Embodiment 10 is the method of any one of embodiments 1 to 9, wherein coke formation on the catalyst is substantially or completely inhibited. Embodiment 11 is the method of any one of embodiments 1 to 10, wherein the pressure remains constant for at least 600 hours, or at least 1200 hours. Embodiment 12 is the method of any one of embodiments 1 to 11, further including the step of providing the product stream to a direct reduced iron unit and reducing iron oxide to iron. Embodiment 13 is the method of any one of embodiments 1 to 12, wherein catalyst has a core/shell structure where the redox-metal oxide layer surrounds the core, and preferably the core is an alumina or alkaline earth metal aluminate core. Embodiment 14 is the method of embodiment 13, wherein the alkaline earth metal aluminate core is magnesium aluminate, calcium aluminate, strontium aluminate, barium aluminate, or any combination thereof. Embodiment 15 is the method of embodiment 14, wherein the alkaline earth metal aluminate core is magnesium aluminate, the redox-metal oxide layer is a cerium oxide layer, the metal dopant is niobium (Nb), indium (In), lanthanum (La), gallium (Ga), or any combination thereof, and the active metal is nickel (Ni). Embodiment 16 is the method of any one of embodiments 1 to 15, wherein: the chemically inactive metal oxide core is alumina or magnesium aluminate; the redox-metal oxide layer is cerium oxide (CeO₂) and the metal dopant is niobium (Nb), indium (In), lanthanum (La), gallium (Ga), or alloy thereof, or any combination thereof; and the active metal is nickel. Embodiment 17 is the method of embodiment 16, The method of claim 16, wherein chemically inactive metal oxide core contains 65 wt. % to 85 wt. % alumina or magnesium aluminate; the redox-metal oxide layer contains 10 wt. % to 20 wt. % cerium oxide; and the nickel is present in an amount of 5 wt. % to 10 wt. %. Embodiment 18 is the method of claim 17, wherein 0.5 wt. % to 2 wt. % of niobium or indium is incorporated into the lattice framework of the cerium oxide layer. Embodiment 19 is the method of any one of embodiments 1 to 18, wherein the redox-metal oxide layer has a thickness of 1 nanometer (nm) to 500 nm, preferably 1 nm to 100 nm, or more preferably 1 nm to 10 nm. Embodiment 20 is a system for direct reduction of iron ore, wherein the system includes a reforming unit capable of producing synthesis gas containing hydrogen (H₂) and carbon monoxide (CO) in a H₂/CO molar ratio of 1.6 to 2.0 from a gaseous reactant stream containing H₂, CO, carbon dioxide (CO₂), methane (CH₄), and water (H₂O). In certain aspects, the reforming unit includes (i) a reaction zone containing the gaseous reactant feed and a catalyst material, and the catalyst material contains a chemically inactive metal oxide core; a redox metal oxide layer deposited on a surface of the metal oxide core, the redox metal oxide layer containing a dopant; and a catalytically active metal deposited on the surface of the redox metal oxide layer; and (ii) a furnace in fluid communication with the reformer, the furnace capable of reducing iron ore using the synthesis gas received from the reformer.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description.

### BRIEF DESCRIPTION OF THE DRAWINGS

Advantages of the present invention may become apparent to those skilled in the art with the benefit of the following detailed description and upon reference to the accompanying drawings.

FIG. 1 depicts a schematic of the catalyst core-shell structure.

FIGS. 2A-2C depict a reaction schematic of oxidation of carbon residuals by the catalyst of the present invention.

FIG. 3 is a schematic of a direct reduction iron system that includes the catalyst of the present invention.

FIG. 4A and FIG. 4B show (FIG. 4A) Scanning Transmission electron microscopic (STEM) images of γ-Al₂O₃ and (FIG. 4B) Energy dispersive X-ray diffraction spectrum EDX spectrum of γ-Al₂O₃ with the electron beam targeted at a point shown in FIG. 4A as “beam”.

FIG. 5A and FIG. 5B show (FIG. 5A) STEM images of 1 wt. % In+25 wt. % CeO₂/γ-Al₂O₃ and (FIG. 5B) EDX spectrum of the sample with the electron beam targeted at a point shown in FIG. 5A as “beam”.

FIG. 6A and FIG. 6B show (FIG. 6A) STEM images of 8 wt. % Ni/i wt. % InO₂+25 wt. % CeO₂/γ-Al₂O₃ and (FIG. 6B) EDX spectrum of the sample with the electron beam targeted at a point shown in FIG. 6A as “beam”.

FIG. 7 shows % CO₂ converted in different feed, Step number, and feed composition listed in Table 2.

FIG. 8 shows % CH₄ converted in different feed, Step number, and feed composition listed in Table 2.

FIG. 9 shows H₂/CO ratio obtained with different feed composition, Step number, and feed composition listed in Table 2.

FIG. 10 shows X-ray diffraction (XRD) patterns for spent catalysts (a) commercial catalyst, (b) Ni/In—CeO₂—MgAl, (c) Ni/Nb—CeO₂—MgAl, and (d) Ni/La—CeO₂—MgAl core-shell catalysts.

FIG. 11 shows temperature programmed oxidation profiles of spent catalysts.

FIG. 12 shows accelerated coking studies conducted over commercial as well as Ni/In—CeO₂—MgAl and Ni/La—CeO₂—MgAl core-shell catalysts.

While the invention is susceptible to various modifications and alternative forms, specific embodiments thereof are shown by way of example in the drawings. The drawings may not be to scale.

### DETAILED DESCRIPTION OF THE INVENTION

The currently available catalysts used to bi-reform hydrocarbons into syngas are prone to growth of carbon residuals (e.g., coke and carbon whiskers) and sintering which can lead to inefficient catalyst performance and ultimately failure of the catalyst after relatively short periods of use. This can lead to inefficient syngas production as well as increased costs associated with its production and ultimately with its use for reducing iron ore to iron.

A discovery has been made that avoids problems associated with deactivation and mechanical degradation of bi-reforming catalysts. The discovery is based on the use of a catalyst that has a particular core-shell structure. The core includes a chemically inert or substantially inert material (e.g., metal oxide core, a clay core, or a zeolite core, or any combination thereof). The shell surrounds the core and has a redox-metal oxide phase that includes a metal dopant incorporated into the lattice framework of the redox-metal oxide phase. An active/catalytic metal is deposited on the surface of the shell. Without wishing to be bound by theory, it is believed that the catalyst having such a core-shell structure as described throughout the specification can oxidize carbon formed on its surface due to methane decomposition and carbon monoxide disproportion. Such a catalyst has a minimal loss of catalytic activity over more than 300 hours of usage. Further, the catalysts of the present invention have increased mechanical strength and decreased costs during the preparation process when compared with currently available bi-reforming of methane-based catalysts. Still further, and in some particular instances wherein the core material is an alkaline aluminate core (e.g., magnesium aluminate MgAl₂O₄)), it is believed that such a core has a high affinity towards CO₂, thereby adsorbs more carbon dioxide and helping to oxidize carbon formed on the catalysts to further reduce the incidence of coking and sintering. The catalyst can be used in the bi-reforming of methane reaction to produce a product stream having a H₂/CO molar ratio of 1.4:1 to 2.0:1, preferably about 1.85:1. This product stream can be used for the direct reduction of iron without further purification.

These and other non-limiting aspects of the present invention are discussed in further detail in the following sections.

### A. Catalyst and Catalyst Structure

The catalyst material can include chemically inactive metal oxide core (e.g., Al₂O₃, alkaline earth metal aluminate, SiO₂, TiO₂, zeolites, amorphous silica alumina, clays, olivine sand, spinels, perovskites, MgO, or ZrO₂, preferably Al₂O₃ or gamma-Al₂O₃ or alkaline earth metal aluminate (e.g., magnesium aluminate, calcium aluminate, strontium aluminate, barium aluminate)); a redox metal oxide (e.g., cerium oxide (CeO₂)) layer deposited on a surface of the metal oxide core, the redox metal oxide layer comprising a dopant (niobium (Nb), indium (In), or lanthanum (La), gallium (Ga), or any combination thereof); and a catalytically active metal (e.g., nickel, rhodium, ruthenium, platinum, or any combination thereof), deposited on the surface of the redox metal oxide layer. In some embodiments, the catalyst can include an alumina or magnesium aluminate core, a CeO₂ redox-metal oxide layer with Nb, In, and/or La as the metal dopant, and Ni as the active metal. In some embodiments, the catalyst includes 65 wt. % to 85 wt. % alumina or magnesium aluminate, 10 wt. % to 20 wt. % cerium oxide; and 5 wt. % to 10 wt. % nickel. In certain aspects, 0.5 wt. % to 2 wt. % of niobium or indium can be incorporated into the lattice framework of the cerium oxide layer. The redox-metal oxide layer can have a thickness of 1 nanometer (nm) to 500 nm, preferably 1 nm to 100 nm, or more preferably 1 nm to 10 nm. In some aspects, the catalyst can have a core/shell structure where the redox-metal oxide layer surrounds the alumina or alkaline earth metal aluminate core. In a preferred embodiment, the catalyst includes a magnesium aluminate core, a cerium oxide layer, a Nb, In, La, Ga, or any combination thereof dopant, and Ni as the active metal.

In some instances, the catalyst does not include a metal dopant, but includes two or more metals deposited on the surface of the redox-metal oxide shell. The core can be chemically inert during the bi-reforming of methane reaction and can also provide sufficient mechanical support for the reactive shell of the catalyst. The shell can have a redox-metal oxide phase that includes a metal dopant (e.g., indium, niobium, or both) incorporated into the lattice framework of the redox-metal oxide phase. The shell can have a greater oxygen mobility when compared with the core. In one particular aspect, the core is Al₂O₃, the redox-metal oxide phase is cerium dioxide, the metal dopant is indium or niobium or both, and the metal deposited on the surface of the shell is nickel, rhodium, ruthenium, or platinum or any combination thereof (e.g., nickel, nickel and platinum or nickel and rhodium). The shell can have a thickness of one atomic monolayer to 100 atomic multilayers (e.g., 1, 10, 20, 30, 40, 50, 60, 70, 80, 90, or 100 atoms thick). In some aspects, the catalyst includes 5 to 50 wt. %, preferably 7 to 20 wt. %, and more preferably from 9 to 15 wt. % of the redox metal oxide phase, 0.1 to 5 wt. %, preferably, 0.75 to 4 wt. %, or more preferably 1 to 3 wt. % of the metal dopant, 1 to 40 wt. %, preferably, 2 to 15 wt. %, or more preferably 5 to 12 wt. % of the metal deposited on the surface of the shell, or combinations thereof. The catalyst can be in particulate form. In some instances, the catalyst has a mean particle size of 100 to 1000 μm, preferably, 200 to 800 μm, or more preferably from 250 to 550 μm. In certain aspects of the invention, the catalyst is self-supporting, however, the catalyst can be supported by a substrate (e.g., glass, a polymer bead, or a metal oxide).

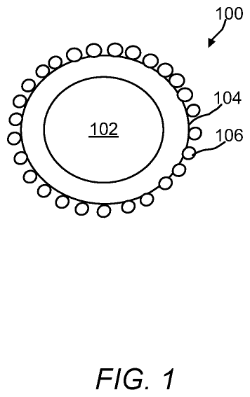

FIG. 1 is a schematic of a core-shell structure of a catalyst of the present invention. Catalyst 100 includes core 102, shell 104, and active metal 106. Core 102 can be a substantially chemically inert material described throughout the specification. Core 102 can provide mechanical strength to the shell 104. Shell 104 can be a material (e.g., a metal oxide) that is capable of undergoing shifts in electronic states (e.g., reduction and oxidation states (redox). Such materials are described throughout the specification. Shell 104 can be formed on the core. In a preferred embodiment, shell 104 substantially or completely surrounds the core. In some aspects, shell 104 can be attached to the outer surface of the core 102. One or more dopants (not shown) described throughout the specification can be included in the crystal lattice of the shell 104. Active metals 106 described throughout the specification can be deposited on top of the shell 104 layer. Active metals 106 are catalytically active during the dry reformation of methane reaction process. The core-shell structure of catalyst 100 can provide an economical, mechanically strong, and highly efficient catalyst for use during a dry reformation of methane reaction. Catalyst 100 can be in any form or shape. In a preferred embodiment, the catalyst is in particulate form. The particulates can have a mean particle size of 100 to 1000 μm, preferably, 200 to 800 μm, or more preferably from 250 to 550 μm, or from 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, 800, 810, 820, 830, 840, 850, 860, 870, 880, 890, 900, 910, 920, 930, 940, 950, 960, 970, or 1000 μm or any value or range there between. Surface area can be measured using Brunauer, Emmett, and Teller (BET) method. In some embodiments, the catalyst is supported by a substrate. Non-limiting examples of a substrate include glass, a polymer bead or metal oxide. The metal oxide can be the same or a different metal oxide as the core material or the shell material.

1. Core

Core 102 can be a metal oxide, a clay, a zeolite, or any combination thereof. The core 102 can be a porous material, a chemically inert material, or both. Non-limiting examples of metal oxides include refractory oxides, alpha, beta or theta alumina (Al₂O₃), activated Al₂O₃, alkaline earth metal aluminate, silicon dioxide (SiO₂), titanium dioxide (TiO₂), magnesium oxide (MgO), calcium oxide (CaO), strontium oxide (SrO), zirconium oxide (ZrO₂), zinc oxide (ZnO), lithium aluminum oxide (LiAlO₂), magnesium aluminum oxide (MgAlO₄), manganese oxides (MnO, MnO₂, Mn₂O₄), lanthanum oxide (La₂O₃), silica gel, aluminosilicates, amorphous silica-alumina, magnesia, spinels, perovskites, or any combination thereof. Non-limiting examples of alkaline earth metal aluminates includes magnesium aluminate, calcium aluminate, strontium aluminate, barium aluminate, or any combination thereof, with magnesium aluminate being particularly preferred. Non-limiting examples of clays include kaolin, diatomaceous earth, activated clays, smectites, palygorskite, sepiolite, acid modified clays, thermally-modified clays, chemically treated clays (e.g., ion-exchanged clays), or any combination thereof. Examples of zeolites include Y-zeolites, beta zeolites, mordenite zeolites, ZSM-5 zeolites, and ferrierite zeolites. All of the materials used to make the supported catalysts of the present invention can be purchased or made by processes known to those of ordinary skill in the art (e.g., precipitation/co-precipitation, sol-gel, templates/surface derivatized metal oxides synthesis, solid-state synthesis, of mixed metal oxides, microemulsion technique, solvothermal, sonochemical, combustion synthesis, etc.). Non-limiting examples of commercial manufacturers of core materials include Zeolyst (U.S.A.), Alfa Aesar® (USA) CRI/Criterion Catalysts and Technologies LP (U.S.A.), and Sigma-Aldrich® (U.S.A.), BASF (Germany), and UNIVAR® (U.S.A.). The core materials can be any shape or form. Non-limiting examples of shapes and forms include a spherical shape, a cylindrical shape (e.g., extrudates, pellets), a hollow cylindrical shape, a pellet shape, or is shaped to have 2-lobes, 3-lobes, or 4 lobes, or is a monolith. The core material can be cylindrical particles having a diameter of about 0.10 to 0.5 centimeters (cm), 0.15 to 0.40 cm, or 0.2 to 0.3 cm in diameter. The surface area of the core material can range from 5 to 300 m²/g, 10 to 280 m²/g, 20 to 270 m²/g, 30 to 250 m²/g, 40 to 240 m²/g, 50 to 230 m²/g, 60 to 220 m²/g, 70 to 210 m²/g, 80 to 200 m²/g, 100 to 150 m²/g, or any range or value there between. In a preferred embodiment, the support material is gamma-alumina extrudates having a diameter of about 0.32 cm (⅛ inch) with a BET surface area of about 230 m²/g. The support material can have a Barrett-Joyner-Halenda (BJH) adsorption cumulative volume of pores between 1.7000 nm and 300.0000 nm of 0.557 cm³/g and BJH Adsorption average pore diameter (4V/A) of 6.78 nm. In some particularly preferred instances where the core includes magnesium aluminate, the core can include 5 wt. % to 60 wt. % MgO, or 10 wt. %, 15 wt. %, 20 wt. %, 25 wt. %, 30 wt. %, 35 wt. %, 40 wt. %, 45 wt. %, 50 wt. %, 55 wt. %, 60 wt. % or any range or value there between.

2. Shell

Shell 104 can be a layer that includes a metal oxide that is able to assume multiple oxidation states depending on the chemical conditions or its redox capability. The reductant and oxidant can be redox couple (e.g., M⁺/M²⁺). Shell 104 can have a thickness of one atomic monolayer to 100 atomic multilayers, or 5 to 80 atomic multilayers, 10 to 60 atomic multilayers, or 20 to 5 atomic multilayers, or 1, 5, 10, 15, 20, 25, 30, 35, 40, 45, 50, 55, 60, 65, 70, 75, 80, 85, 90 or 100 atomic multilayers or any range or value there between. Non-limiting examples of metal oxides that can have a redox-metal oxide phase (e.g., redox couple) include cerium (Ce) oxide, an iron (Fe) oxide, a titanium (Ti) dioxide, a manganese (Mn) oxide, a niobium (Nb) oxide, a tungsten (W) oxide, or a zirconium (Zr) oxide, preferably a cerium oxide. Such metal oxides can form a cerium oxide phase, an iron oxide phase, a titanium dioxide phase, a manganese oxide phase, a niobium oxide phase, a tungsten oxide phase, or a zirconium oxide phase under certain chemical conditions (e.g., heat). The amount of redox-metal oxide can range from 5 to 50 wt. %, 7 to 20 wt. %, 9 to 15 wt. %, or 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49% or 50% by weight based on the total weight of catalyst. The metal oxide phase (or metal oxide layer) can include one or more metal dopants. The metal dopant can be incorporated into the crystal lattice of the metal oxide. A dopant can provide mechanical strength to the metal oxide lattice, decrease the amount of energy required to remove an oxygen anion from the metal oxide crystal lattice, or both. Non-limiting examples of metal dopants include indium (In), gallium (Ga), niobium (Nb), lanthanum (La), germanium (Ge), arsenic (As), selenium (Se), tin (Sn), antimony (Sb), tellurium (Te), thallium (Tl), or lead (Pb), or any combination thereof, preferably indium. The amount of redox-metal oxide can range from 0.1 to 5 wt. %, 0.75 to 4 wt. %, 1 to 3 wt. %, or 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%. 4.1%, 4.2%, 4.3%, 4.4%, 4.5%, 4.6%, 4.7%, 4.8%, 4.9% or 5.0% by weight based on the total weight of catalyst. The metal oxides and metal dopants can be purchased from commercial manufactures such as Sigma-Aldrich®.

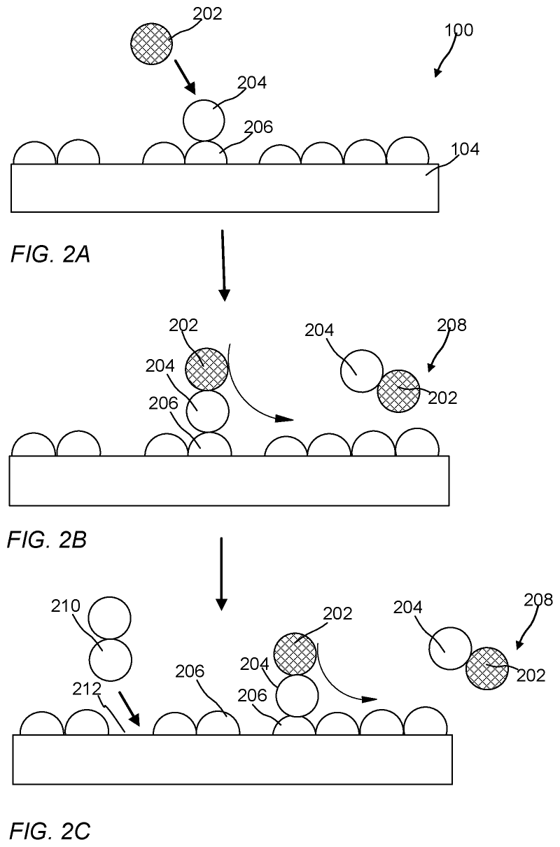

The redox-metal oxide phase can change oxidation states. Therefore, the oxygen anions bonded to the crystal lattice can be released and other oxygen compounds (e.g., molecular oxygen, superoxides, and ozone) can be absorbed, thereby the oxygen in shell 104 has mobility. Due to the redox capability of the metal oxide, shell 104 can have a greater oxygen mobility than core 102. Due to the structure of the metal redox phase, the removal of the oxygen anion can occur without disrupting or destroying the crystal lattice of the metal oxide. As more oxygen atoms are abstracted, the concentration of vacancies can increase, thereby leaving behind two electrons to be shared between the metal atoms. The oxygen atoms can be abstracted from any surface or subsurface of the metal oxide. In a similar manner, the metal can absorb molecular oxygen (O₂) into the vacancy which oxidizes some of the metals due to the increase in available electrons. Without wishing to be bound by theory, it is believed that the ability of the shell to store and release oxygen anions through this redox process assists in oxidizing carbon deposited on the surface of the catalyst to a carbon monoxide. For example, the carbon atom can deposit on the absorbed oxygen on the surface of the metal oxide and be released as carbon monoxide as shown in FIG. 2. FIG. 2 is a schematic of the oxidation of carbon by contact with the redox-metal oxide phase of the catalyst 100. In FIG. 2, for simplicity, active metal 106 and the core 102 are not depicted. Referring to FIG. 2A, carbon atom 202 is attracted to oxygen atom 204 that is bound to metal atom 206 of metal-redox phase of shell 104. As shown in FIG. 2B, carbon atom 202 bonds to the oxygen atom 204 to form carbon monoxide 208. In FIG. 2C, carbon monoxide 208 can diffuse from shell 104 and molecular oxygen 210 can be absorbed into a vacancy 212 to continue the oxidation of carbon residual process.

3. Active Metals

Catalyst 100 can include one or more active (catalytic) metals to promote the reforming of methane to carbon dioxide. The active metals 106 can be attached to the surface of shell 104 (See, FIG. 1). The active metal(s) 106 can include one or more metals from Columns 7-11 of the Periodic Table (Groups VIIB, VIII, and IB). Non-limiting examples of the active metals include nickel (Ni), rhodium (Rh), ruthenium (Re), iridium (Ir), platinum (Pt), palladium (Pd), gold (Au), silver (Ag), cobalt (Co), manganese (Mn), copper (Cu), or any combination or alloy thereof, preferably nickel, rhodium, ruthenium, or platinum, or any combination or alloy thereof. The amount of active metal on the shell 104 depends, inter alia, on the catalytic (metal) activity of the catalyst. In some embodiments, the amount of catalyst present on the shell ranges from 1 to 40 wt. %, 2 to 15 wt. %, 5 to 12 wt. %, or 1%, 2%, 3%, 4%, 5%, 6%, 7%, 8%, 9%, 10%, 11%, 12%, 13%, 14%, 15%, 16%, 17%, 18%, 19⁰/a, 20%, 21%, 22%, 23%, 24%, 25%, 26%, 27%, 28%, 29%, 30%, 31%, 32%, 33%, 34%, 35%, 36%, 37%, 38%, 39%, 40% by weight based on the total weight of catalyst. In some instances, the active metal can be a binary alloy (M1M2) or a tertiary alloy (M1M2M3), where M1 is nickel (Ni), and M2 and M3 are each rhodium (Rh), ruthenium (Ru), iridium (Ir), platinum (Pt), palladium (Pd), gold (Au), silver (Ag), cobalt (Co), manganese (Mn), copper (Cu), zinc (Zn), iron (Fe), molybdenum (Mo), or zirconium (Zr). In a particular instance, the active metal can be binary alloy (M1M2) where M1 is nickel and M2 is rhodium (Rh) or platinum (Pt) (e.g., NiRh, or NiPt).

### B. Preparation of Core-Shell Catalysts

The catalyst of the present invention can be made by processes that provide for a core-shell structure. As further illustrated in the Examples, the catalyst can be made using known catalyst preparation methods (e.g., dry or wet impregnation, spraying methods, homogeneous deposition precipitation, atomic layer deposition techniques, dip coating, etc.). In a non-limiting example, a first metal salt (e.g., redox-metal salt) and a second metal salt (e.g., salt of the metal dopant) can be solubilized in a solution (e.g., water). Examples of the first metal salt includes nitrates, ammonium nitrates, carbonates, oxides, hydroxides, halides of Ce, Fe, Ti, Mn, Nb, W, or Zr. Examples of the second metal salt include nitrates, ammonium nitrates, carbonates, oxides, hydroxides, halides of Column 7-12 metals. In a particular embodiment, NbCh₅, or InCl₃.4H₂O, and (NH₄)₂Ce(NO₃)₆, can be solubilized in deionized water. The weight ratio of the first metal salt to the second metal salt present in the solution can be at least 5:1, 5:1 to 30:1, 7:1 to 20:1, 10:1 to 15:1, or 5, 6, 7, 8, 9, 10, 11, 12, 13, 14, 15, 16, 17, 18, 19, 20, 21, 22, 23, 24, 25, 26, 27, 28, 29, 30 to 1 or any range or value there between. In some embodiments, the second metal salt (metal dopant is not used). The solution can be pro volume impregnated with the core material (e.g., a metal oxide core). In a particular embodiment, the solution is pore volume impregnated with magnesium aluminate extrudates. The impregnated material can be dried an average temperature of 50 to 150° C., 75 to 100° C., 80 to 90° C., or 50, 55, 60, 65, 70, 75, 80, 85, 90, 95, 100, 105, 110, 115, 120, 125, 130, 135, 140, 145, or 150° C. for 2, 3, 4, 5, 6, 7, 8, 9, 10 hours or until the impregnated material is deemed to be dry. The dried impregnated material can be calcined (converted to the metal oxide) at an average temperature of 500 to 800° C., 600 to 700° C., or 500, 525, 550, 575, 600, 625, 650, 675, 700, 725, 750, 775, or 800° C. at 2, 3, 4 hours or until the impregnated material is deemed to be sufficiently calcined to obtain a core-shell structure where the shell surrounds the core and the shell has a redox-metal oxide phase formed from the first metal salt and metal dopant formed from the second metal salt incorporated into the lattice framework of the redox-metal oxide phase. This process can be repeated to obtain a shell having a desired amount of dopants to tune the oxygen mobility of the catalytic material.

In some embodiments, the solutions can be impregnated with the core material in a stepwise manner. For example, the redox metal-salt can be pore volume impregnated with the core material, dried and calcined and, then dopant metal can be pore volume impregnated with the core material, dried and calcined to form the core-shell material. This process can be repeated to obtain a shell having a desired amount of dopants to tune the oxygen mobility of the catalytic material. The redox metal oxide layer thickness can be increased by repeating the redox metal-salt impregnated step. Incorporation of the dopant in the redox metal oxide (e.g., CeO₂) phase can be determined using X-ray diffraction methods. By way of example, a catalyst containing CeO₂ and dopant will show a slight shifting in diffraction patterns related to CeO₂ due to the incorporation of dopant. Some of dopant can be dispersed in the core, however, a majority of the dopant remains in shell and disperses homogeneously in shell during calcination.

One or more active metals can be deposited on the surface of the shell using known metal deposition methods (e.g., impregnations, spraying, chemical vapor depositing, etc.). In a non-limiting example, the core-shell structure can be slowly impregnated with an aqueous solution of active metal. For example, the active metal solution can be added dropwise to the metal oxide extrudates which were under constant mechanical stirring. The impregnated material can be dried at an average temperature of 50 to 120° C., 75 to 110° C., 80 to 90° C., or 50, 55, 60, 65, 70, 75, 80, 85, 90, 95, 100, 105, 110, 115, or 120° C. for 0.5, 1, or 2 hours or until the impregnated material is deemed to be dry. The dried impregnated core-shell material can be calcined (converted to the metal oxide) at an average temperature of 500 to 850° C., 600 to 800° C., or 500, 525, 550, 575, 600, 625, 650, 675, 700, 725, 750, 775, 800, 825, or 850° C. at 0.5, 1, or 2 hours or until the impregnated material is deemed to be sufficiently calcined to obtain the catalyst having a core-shell structure with active metal deposited on the surface of the shell (e.g., catalyst 100 in FIG. 1). The resulting core-shell catalyst can be crushed and sieved to a desired size, e.g., 300 to 500 μm.

The redox oxide precursor and active metal precursor impregnation can be performed on either powder or pre-shaped structures such as cylindrical hollow disc, cylindrical disc, sphere, 4- to 10-holes cylindrical disc shaped structure or 0.4 mm to 4 mm extrudates. If impregnation is performed on powders, the final catalyst can be pressed into different forms using pelletizing tools.

As illustrated in the Examples section, the produced core-shell catalysts of the invention are sinter and coke resistant materials at elevated temperatures, such as those typically used in syngas production or dry methane reformation reactions (e.g., 700° C. to 950° C. or a range from 725° C., 750° C., 775° C., 800° C., 900° C., to 950° C.). Further, the produced catalysts can be used effectively in carbon dioxide reforming of methane reactions at a temperature range from 700° C. to 950° C. or from 800° C. to 900° C., a pressure range of 0.1 MPa, and/or at a gas hourly space velocity (GHSV) range from 500 to 10000 h⁻¹, preferably a temperature of 800° C., a pressure of 0.1 MPa, and a GHSV of 75,000 h⁻¹.

### C. Bi-Reforming of Methane

Also disclosed is a method of producing hydrogen and carbon monoxide (syngas) from a bi-reforming of methane reaction. In a particular instance, syngas can be produced from a methane, water, carbon monoxide, hydrogen, nitrogen and carbon dioxide containing reactant gas mixture feed. The method can include contacting the reactant gas mixture with any one of the catalysts of the present invention under sufficient conditions to produce hydrogen and carbon monoxide with a methane conversion of at least 50%, 60%, 70% 80% or more. Such conditions sufficient to produce the gaseous mixture can include a temperature range of 700° C. to 1000° C., from 750° C. to 950° C. or from 725° C., 750° C., 775° C., 800° C., 900° C., 1000° C., at pressure range of 0.1 MPa to 2.0 MPa, and/or a gas hourly space velocity (GHSV) ranging from 500 to 100,000 h⁻¹ or a range from 500 h⁻¹, 1000 h⁻¹, 5000 h⁻¹, 10,000 h⁻¹, 20,000 h⁻¹, 30,000 h⁻¹, 40,000 h⁻¹, 50,000 h⁻¹, 60,000 h⁻¹, 70,000 h⁻¹, 80,000 h⁻¹, 90,000 h⁻¹, to 100,000 h⁻¹. In a particular instance, an average temperature from 750 to 800° C., a pressure of 0.1 MPa, and a GHSV of 70,000 to 75,000 h⁻¹ is used. Under such conditions, the methane conversion is 60 to 98%, preferably 80 to 95. The H₂/CO ratio can be at least 1.4:1 to 2.0:1, or 1.5:1 to 1.95:1, 1.7:1 to 1.90:1, or at least, equal to, or between any two of 1.4:1, 1.45:1, 1.5:1, 1.55:1, 1.6:1, 1.65:1, 1.7:1, 1.75:1, 1.8:1, 1.85:1, 1.9:1, 1.95:1 and 2, or about 1.85:1. In particular instances, the hydrocarbon includes methane and the oxidants are water and carbon dioxide. In certain aspects, the carbon residual formation or coking is reduced or does not occur on the core-shell structured catalyst and/or sintering is reduced or does not occur on the core-shell structured catalyst. In particular instances, carbon residuals formation or coking and/or sintering is reduced or does not occur when the core-shell structured catalyst is subjected to temperatures at a range of greater than 700° C. or 800° C. or a range from 725° C., 750° C., 775° C., 800° C., 900° C., to 950° C. In particular instances, the range can be from 700° C. to 950° C. or from 750° C. to 1000° C. at a pressure of 0.1 to 0.2 MPa. Without wishing to be bound by theory it is believed that no or substantially little sintering occurs because the oxygen mobility is enhanced in the lattice of the catalyst, thus oxidizing coke from hydrocarbon decomposition, thereby, making the active sites available for a longer period. In instances when the produced catalytic material is used in bi-reforming methane reactions, the water and carbon dioxide in the gaseous feed mixture can be obtained from various sources. In a direct reduced iron system, carbon dioxide and water can be produced during reduction of iron ore in shaft furnace. Carbon monoxide converts to carbon dioxide and hydrogen converts to water in reduction process. The reactant gas mixture can include natural gas or methane, liquefied petroleum gas comprising C₂-C₅ hydrocarbons, C₆+ heavy hydrocarbons (e.g., C₆ to C₂₄ hydrocarbons such as diesel fuel, jet fuel, gasoline, tars, kerosene, etc.), oxygenated hydrocarbons, and/or biodiesel, alcohols, or dimethyl ether. In particular instances, the reactant gas mixture has an overall oxygen to carbon atomic ratio equal to or greater than 0.9. The method can further include isolating and/or storing the produced gaseous mixture. The method can also include separating hydrogen from the produced gaseous mixture (such as by passing the produced gaseous mixture through a hydrogen selective membrane to produce a hydrogen permeate). The method can include separating carbon monoxide from the produced gaseous mixture (such as passing the produced gaseous mixture through a carbon monoxide selective membrane to produce a carbon monoxide permeate).

### D. Direct Reduced Iron System

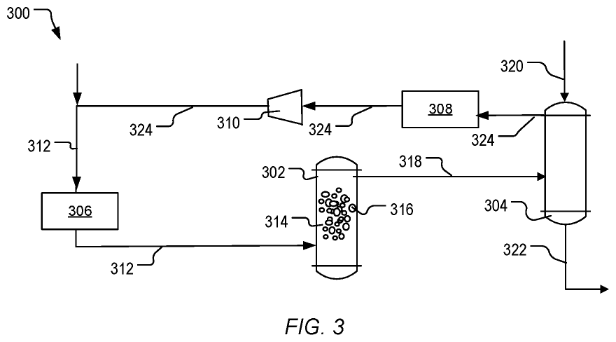

In some embodiments, the bi-reformer unit used for bi-reforming of methane can be used in a direct reduced iron (DRI) system. Referring to FIG. 3, a DRI system is depicted. DRI system can include bi-reformer unit 302, shaft furnace 304, heat recovery system 306, scrubber 308, and cooling unit 310. Other heating and/or cooling devices (e.g., insulation, electrical heaters, jacketed heat exchangers in the wall) or controllers (e.g., computers, flow valves, automated values, etc.) that are necessary to control the reaction temperature and pressure of the reaction mixture. While only one unit is shown, it should be understood that multiple units can be housed in one unit. In system 300, reactant gaseous feed stream 312 can enter bi-reforming unit 302. Reactant gaseous feed stream 312 can include hydrocarbons (e.g., methane, ethane, propane, etc., preferably natural gas), water, carbon monoxide, hydrogen, carbon dioxide, and optional inert gas. In one preferred aspect, the feed stream can have a composition of 14 to 16 vol. % CO, 12 to 14 vol. % CO₂, 32 to 36 vol. % H₂, 16.5 to 19.5 vol. % H₂O, 14 to 18 vol. % CH₄, and 3.5 to 4.5 vol. % N₂. Bi-reforming unit 302 can include a reaction zone 314, which includes catalyst 316 of the present invention. In reaction zone 314, reactant feed 312 can contact catalyst 316 and produce product stream 318. Product stream 318 can have a H₂/CO molar ratio of 1.4:1 to 2:0:1, or about 1.85:1. Product stream 318 can exit bi-reforming unit 302 and enter shaft furnace 304. Iron oxide stream 320 can enter shaft furnace 304 and contact product stream 318. Contact of iron oxide stream 320 with product stream 318 can produce direct reduced iron stream 322 and recycle stream 324. Contact temperatures in furnace 304 can be at temperatures necessary to reduce the iron oxide. Recycle stream 324 can exit furnace 304, pass through scrubber 308 to remove particulates and/or by-products of the iron reduction process, and then pass cooling unit 310 (e.g., compressor or a series of compressors) and be combined with reactant feed stream 312. The amount of hydrocarbon, CO₂, CO, and hydrogen can be adjusted based to control the molar ratio of H₂/CO. The combined stream can pass through heat recovery system 306, and then enter bi-reformer unit 302 to continue the cycle. As shown in the FIG. 3, the fuel value depleted gas (recycle stream 324) is recycled to the reformer along with additional natural gas. Along the path, the excess moisture in the depleted gas is removed to obtain the feed desired composition of 14 to 16 vol. % CO, 12 to 14 vol. % CO₂, 32 to 36 vol. % H₂, 16.5 to 19.5 vol % H₂O, 14 to 18 vol. % CH₄, and 3.5 to 4.5 vol. % N₂.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Example 1

### Synthesis of Catalysts

Metal precursor salts used for the catalyst of the present invention include, RhCl₃, H₂PtCl₆, NiCl₃.6H₂O, La(NO₃)₃.6H₂O, NbCl₃, InCl₃.4H₂O, (NH₄)₂Ce(NO₃)₆. All chemicals were purchased from SigmaMillipore (USA) and used as received. MgAl₂O₄ extrudates 2 mm diameter and 5 mm long and with various amount of MgO were supplied by Pacific Industrial Development Company (PIDC) (Germany). All gases used has a purity of 99.999 vol. %.

Step 1: Cerium ammonium nitrate (2.38 g) and niobium chloride (0.0872 g) were dissolved in deionized water (2.83 mL). The resultant solution was impregnated with MgAl₂O₄ extrudates (5.0 g). After the impregnation, the impregnated material was dried at 80° C. in an oven under the flow of air. Drying was continued at 120° C. for 2 h followed by calcination at 550° C. for 3 h. The resultant material was yellowish in color.

Step 2: Nickel chloride hexahydrate (0.911 g) was weighed and dissolved in deionized water (1.63 mL). The resultant solution was slowly impregnated with material (3 g) obtained in Step 1. The material was dried at 120° C. for 2 h and calcined at 850° C. for 4 h.

Catalysts with 1 wt. % In, 1 wt. % Ga, and 1 wt. % La dopants were prepared by following similar protocols as explained above, with the dopant metal salt added in Step 1. Catalyst with active metals Pt or Rh were prepared by replacing rhodium chloride with chloroplatinic acid. Table 1 is a list of catalysts prepared and tested, where MgAl stands for MgAl₂O₄.

TABLE 1

| Catalyst | Composition |
|---|---|
| Ni/Nb—CeO₂—MgAl | 15 wt. % CeO₂ + 1 wt. % Nb + 7.5 wt. % Ni + 76.5 wt. % MgAl₂O₄ |
| Ni/Ga—CeO₂—MgAl | 15 wt. % CeO₂ + 1 wt. % Ga + 7.5 wt. % Ni + 76.5 wt. % MgAl₂O₄ |
| Ni/La—CeO₂ | 15 wt. % CeO₂ + 1 wt. % La + 7.5 wt. % Ni + 76.5 wt. % MgAl₂O₄ |
| Ni/In—CeO₂—MgAl | 15 wt. % CeO₂ + 1 wt. % In + 7.5 wt. % Ni + 76.5 wt. % MgAl₂O₄ |
| Ni/CeO₂—MgAl | 15 wt. % CeO₂ + 7.5 wt. % Ni + 77.5 wt. % MgAl₂O₄ |
| NiRh/Nb—CeO₂—MgAl | 15 wt. % CeO₂ + 1.43 wt. % Nb + 2.5 wt. % Rh + 7.5 wt. % Ni + 73.57 wt. % MgAl₂O₄ |
| NiRh/Bi—CeO₂—MgAl | 15 wt. % CeO₂ + 1.43 wt. % Bi + 2.5 wt. % Rh + 7.5 wt. % Ni + 73.57 wt. % MgAl₂O₄ |
| NiRh/Ga—CeO₂—MgAl | 15 wt. % CeO₂ + 1.43 wt. % Ga + 2.5 wt. % Rh + 7.5 wt. % Ni + 73.57 wt. % MgAl₂O₄ |
| NiRh/La—CeO₂—MgAl | 15 wt. % CeO₂ + 1.43 wt. % La + 2.5 wt. % Rh + 7.5 wt. % Ni + 73.57 wt. % MgAl₂O₄ |
| NiRh/In—CeO₂—MgAl | 15 wt. % CeO₂ + 1.43 wt. % In + 2.5 wt. % Rh + 7.5 wt. % Ni + 73.57 wt. % MgAl₂O₄ |
| NiRh/CeO₂—MgAl | 15 wt. % CeO₂ + 2.5 wt. % Rh + 7.5 wt. % Ni + 75 wt. % MgAl₂O₄ |
| NiPt/Nb—CeO₂—MgAl | 15 wt. % CeO₂ + 1.43 wt. % Nb + 2.5 wt. % Pt + 7.5 wt. % Ni + 73.57 wt. % MgAl₂O₄ |
| NiPt/Bi—CeO₂—MgAl | 15 wt. % CeO₂ + 1.43 wt. % Bi + 2.5 wt. % Pt + 7.5 wt. % Ni + 73.57 wt. % MgAl₂O₄ |
| NiPt/Ga—CeO₂—MgAl | 15 wt. % CeO₂ + 1.43 wt. % Ga + 2.5 wt. % Pt + 7.5 wt. % Ni + 73.57 wt. % MgAl₂O₄ |
| NiPt/La—CeO₂—MgAl | 15 wt. % CeO₂ + 1.43 wt. % La + 2.5 wt. % Pt + 7.5 wt. % Ni + 73.57 wt. % MgAl₂O₄ |
| NiPt/In—CeO₂—MgAl | 15 wt. % CeO₂ + 1.43 wt. % In + 2.5 wt. % Pt + 7.5 wt. % Ni + 73.57 wt. % MgAl₂O₄ |
| NiPt/CeO₂—MgAl | 15 wt. % CeO₂ + 2.5 wt. % Pt + 7.5 wt. % Ni + 75 wt. % MgAl₂O₄ |
| Ni0.1Pt/In—CeO₂—MgAl | 15 wt. % CeO₂ + 1.0 wt. % In + 0.1 wt. % Pt + 15 wt. % Ni + 68.9 wt. % MgAl₂O₄ |
| Ni15/In—CeO₂—MgAl | 15 wt. % CeO₂ + 1.0 wt. % In + 15 wt. % Ni + 69 wt. % MgAl₂O₄ |
| Ni/InLa—CeO₂—MgAl | 15 wt. % CeO₂ + 1 wt. % In + 1 wt. % La 7.5 wt. % Ni + 75.5 wt. % MgAl₂O₄ |
| Ni/InNb—CeO₂—MgAl | 15 wt. % CeO₂ + 1 wt. % In + 1% Nb 7.5 wt. % Ni + 75.5 wt. % MgAl₂O₄ |
| Ni/InZr—CeO₂—MgAl | 15 wt. % CeO₂ + 1 wt. % In + 1% Zr 7.5 wt. % Ni + 75.5 wt. % MgAl₂O₄ |
| Ni/InSn—CeO₂—MgAl | 15 wt. % CeO₂ + 1 wt. % In + 1% Sn 7.5 wt. % Ni + 75.5 wt. % MgAl₂O₄ |
| Ni/Nb—CeO₂—Al | 15 wt. % CeO₂ + 1 wt. % Nb + 7.5 wt. % Ni + 76.5 wt. % Al₂O₃ |
| Ni/Ga—CeO₂—Al | 15 wt. % CeO₂ + 1 wt. % Ga + 7.5 wt. % Ni + 76.5 wt. % Al₂O₃ |
| Ni/La—CeO₂ | 15 wt. % CeO₂ + 1 wt. % La + 7.5 wt. % Ni + 76.5 wt. % Al₂O₃ |
| Ni/In—CeO₂—Al | 15 wt. % CeO₂ + 1 wt. % In + 7.5 wt. % Ni + 76.5 wt. % Al₂O₃ |
| Ni/CeO₂—Al | 15 wt. % CeO₂ + 7.5 wt. % Ni + 77.5 wt. % Al₂O₃ |
| NiRh/Nb—CeO₂—Al | 15 wt. % CeO₂ + 1.43 wt. % Nb + 2.5 wt. % Rh + 7.5 wt. % Ni + 73.57 wt. % Al₂O₃ |
| NiRh/Bi—CeO₂—Al | 15 wt. % CeO₂ + 1.43 wt. % Bi + 2.5 wt. % Rh + 7.5 wt. % Ni + 73.57 wt. % Al₂O₃ |
| NiRh/Ga—CeO₂—Al | 15 wt. % CeO₂ + 1.43 wt. % Ga + 2.5 wt. % Rh + 7.5 wt. % Ni + 73.57 wt. % Al₂O₃ |
| NiRh/La—CeO₂—Al | 15 wt. % CeO₂ + 1.43 wt. % La + 2.5 wt. % Rh + 7.5 wt. % Ni + 73.57 wt. % Al₂O₃ |
| NiRh/In—CeO₂—Al | 15 wt. % CeO₂ + 1.43 wt. % In + 2.5 wt. % Rh + 7.5 wt. % Ni + 73.57 wt. % Al₂O₃ |
| NiRh/CeO₂—Al | 15 wt. % CeO₂ + 2.5 wt. % Rh + 7.5 wt. % Ni + 75 wt. % Al₂O₃ |
| NiPt/Nb—CeO₂—Al | 15 wt. % CeO₂ + 1.43 wt. % Nb + 2.5 wt. % Pt + 7.5 wt. % Ni + 73.57 wt. % Al₂O₃ |
| NiPt/Bi—CeO₂—Al | 15 wt. % CeO₂ + 1.43 wt. % Bi + 2.5 wt. % Pt + 7.5 wt. % Ni + 73.57 wt. % Al₂O₃ |
| NiPt/Ga—CeO₂—Al | 15 wt. % CeO₂ + 1.43 wt. % Ga + 2.5 wt. % Pt + 7.5 wt. % Ni + 73.57 wt. % Al₂O₃ |
| NiPt/La—CeO₂—Al | 15 wt. % CeO₂ + 1.43 wt. % La + 2.5 wt. % Pt + 7.5 wt. % Ni + 73.57 wt. % Al₂O₃ |
| NiPt/In—CeO₂—Al | 15 wt. % CeO₂ + 1.43 wt. % In + 2.5 wt. % Pt + 7.5 wt. % Ni + 73.57 wt. % Al₂O₃ |
| NiPt/CeO₂—Al | 15 wt. % CeO₂ + 2.5 wt. % Pt + 7.5 wt. % Ni + 75 wt. % Al₂O₃ |
| Ni0.1Pt/In—CeO₂—Al | 15 wt. % CeO₂ + 1.0 wt. % In + 0.1 wt. % Pt + 15 wt. % Ni + 68.9 wt. % Al₂O₃ |
| Ni15/In—CeO₂—Al | 15 wt. % CeO₂ + 1.0 wt. % In + 15 wt. % Ni + 69 wt. % Al₂O₃ |
| Ni/InLa—CeO₂—Al | 15 wt. % CeO₂ + 1 wt. % In + 1 wt. % La 7.5 wt. % Ni + 75.5 wt. % Al₂O₃ |
| Ni/InNb—CeO₂—Al | 15 wt. % CeO₂ + 1 wt. % In + 1 wt. % Nb 7.5 wt. % Ni + 75.5 wt. % Al₂O₃ |
| Ni/InZr—CeO₂—MgAl | 15 wt. % CeO₂ + 1 wt. % In + 1 wt. % Zr 7.5 wt. % Ni + 75.5 wt. % Al₂O₃ |
| Ni/InSn—CeO₂—MgAl | 15 wt. % CeO₂ + 1 wt. % In + 1 wt. % Sn 7.5 wt. % Ni + 75.5 wt. % MgAl₂O₄ |

### Example 2

### Characterization of Catalysts

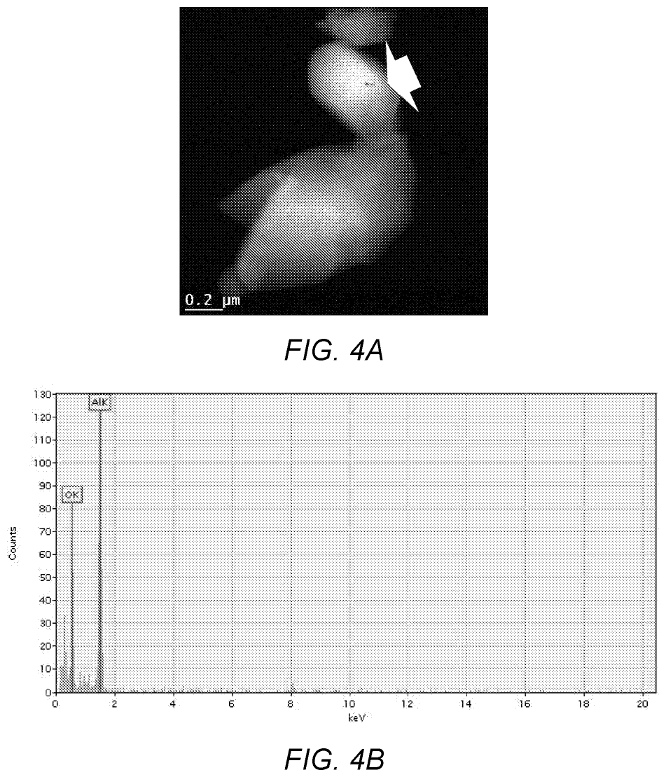

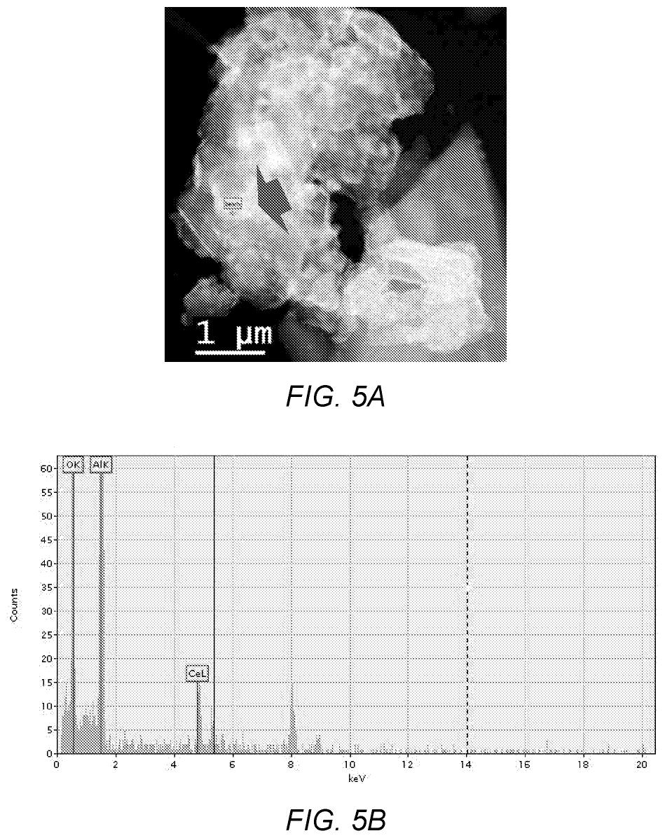

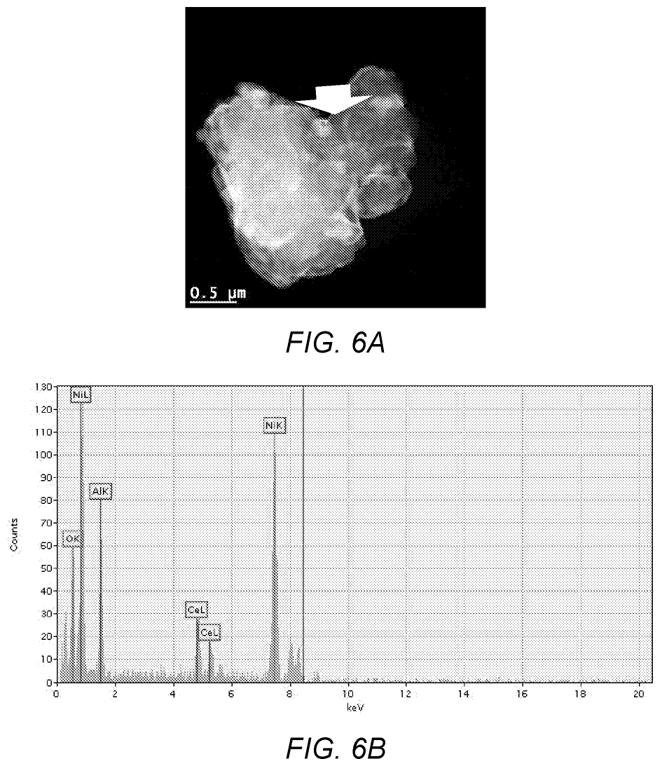

FIGS. 4A and 4B show the Scanning transmission electron micrograph (STEM) of γ-Al₂O₃ calcined at 850° C. for 4 hours and Energy dispersive X-ray diffraction spectrum (EDX). The analysis showed that sample contains only ‘Al’ and ‘O’ elements. The analysis was extended to sample containing 1 wt. % In/25 wt. % CeO₂/γ-Al₂O₃ and found that multi-layer of CeO₂ has covered Al₂O₃(FIGS. 5A and 51B). Presence of the CeO₂ layer was indicated via increased brightness as molecular weight of Ce is more than that of Al. In addition, the presence was confirmed by EDX analysis. 10-15 wt. % CeO₂ loading was not enough to distinguish between CeO₂ and Al₂O₃ via brightness, but about 25 wt. % was sufficient to form multi-layer of CeO₂, which enabled distinction between two different oxide layers, i.e., CeO₂ and Al₂O₃. Moreover, due to low loading of ‘In’ in the CeO₂, phase it was not identifiable in spot EDX analysis. FIGS. 6A and 6B show STEM and EDX for of 8 wt. % Ni/25 wt. % CeO_{2/7}-Al₂O₃ catalyst sample. The image showed that the Ni particle are sitting on the CeO₂ layer and difficult to identify by mere comparing brightness. However, EDX analysis on the spherical particles confirmed the particles were indeed metallic ‘Ni’ and located specifically on CeO₂ layer.

### Example 3

### Bi-Reforming of Methane

Catalysts testing was performed in a high throughput reactor system supplied by Avantium BV (Netherlands). Reactors were of plug flow type and made up of steel, with an inner quartz liner. The quartz liner with 4 mm in inner diameter and 60 cm in length was used to avoid coking due to methane cracking on steel surface. Catalyst pellets were crushed and sieved between 300-500 μm. Catalyst sieve fraction was placed on top of inert material inside the quartz liner. A feed gas mixture of 13% CO₂+16% CH₄+34% H₂+18% H₂O+15% CO+4% Ar was made by mixing pure gases and evaporating water. Argon was used as an internal standard for Mass spectrometric analysis. The catalyst in oxidized state was heated to 800° C. in the presence of 100% Ar and they actual gas mixture feed was passed over the catalyst bed. A mass spectrometer from Thermo Scientific Model Thermo BT was used for gas analysis. Methane conversion was calculated as follows.

$$Methane conversion = \frac{mol of methane converted}{mol of methane in feed} \times 100$$

The ratio of hydrogen to carbon monoxide is calculated as follows,

$$H 2 / CO = \frac{mol of Hydrogen in product}{mol of carbon monoxide in product} \times 100$$

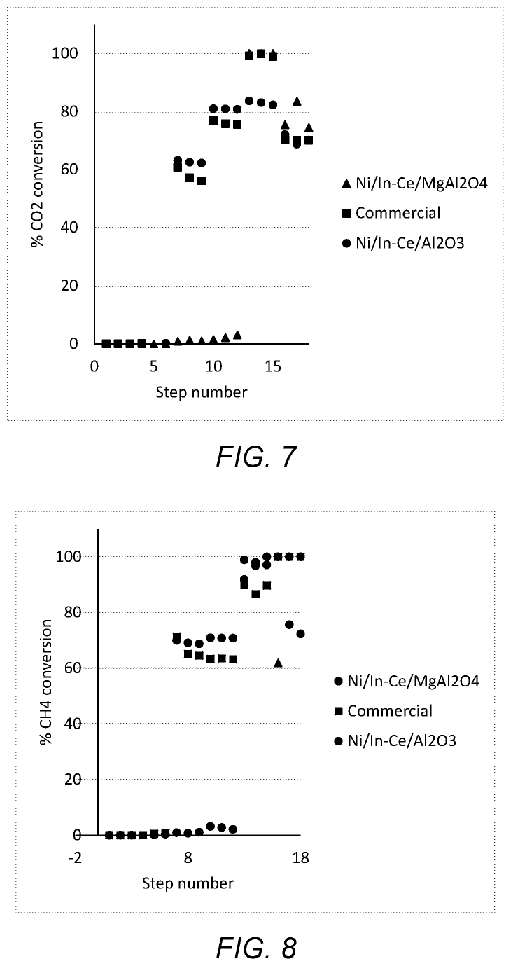

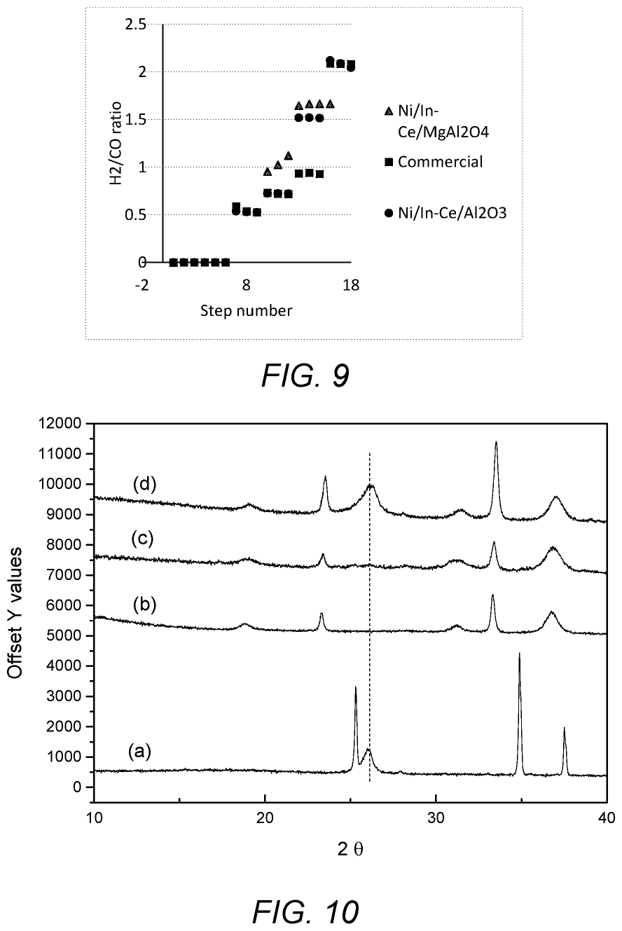

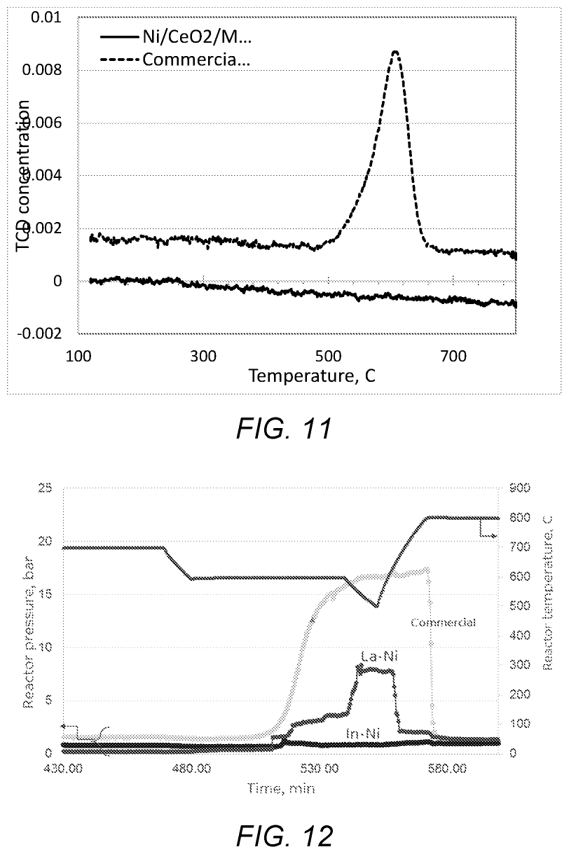

During the plant start up, usually a mixture of N₂ and CO₂ flows through the catalyst bed while temperature in the latter ramps up. Usually the fresh catalyst was in oxidized state, which reduced to metallic state during initial stages of reforming when CH₄ gas replaces portion of CO₂ and N₂. It was crucial that catalyst withstands high concentration of CO₂ and adjusts to changing redox gas atmosphere during start-up phase. Table 2 gives the variation of feed composition at different stages of temperature ramp. Three catalysts were chosen for study and were subjected to same feed and reaction conditions. Experiments were started from 550° C. with 60% CO₂ in the feed. Gradually, temperature was increased to 600° C., 650° C., 700° C., 750° C. and 800° C. with incremental addition of CH₄ in the feed, while replacing CO₂. In addition, at 800° C. as a final check, actual reformer feed was fed and catalyst performance was monitored. As expected, all three catalysts underwent in-situ reduction and activation. Ni/In—Ce/Al₂O₃ showed better performance than commercial catalysts in all conditions (FIGS. 7 and 8), the H₂/CO ratio was also better for former than latter (FIG. 9). Ni/In—Ce/MgAl₂O₄ showed sluggish performance as the catalyst activation takes place only around 780° C., whereas both Commercial and (Ni/In—Ce/Al₂O₃) activate around 400° C. At higher temperature>850° C. the performance of both (Ni/In—Ce/Al₂O₃) and (Ni/In—Ce/MgAl₂O₄) was expected to be same since both catalyst activate below 800′° C.

TABLE 2

| | | | Feed gas composition | | | | | |
|---|---|---|---|---|---|---|---|---|
| | Time, | Temp., | CO₂, | CH₄, | He, | H₂, | CO, | H₂O, |
| Steps | h | ° C. | Vol %. | Vol. % | Vol. % | Vol. % | Vol. % | Vol % |
| 1 | 2 | 550 | 60 | 0 | 40 | | | |
| 2 | 4 | 550 | 60 | 0 | 40 | | | |
| 3 | 6 | 550 | 60 | 0 | 40 | | | |
| 4 | 8.5 | 600 | 50 | 10 | 40 | | | |
| 5 | 10.5 | 600 | 50 | 10 | 40 | | | |
| 6 | 11.5 | 600 | 50 | 10 | 40 | | | |
| 7 | 14 | 650 | 40 | 20 | 40 | | | |
| 8 | 16 | 650 | 40 | 20 | 40 | | | |
| 9 | 18 | 650 | 40 | 20 | 40 | | | |
| 10 | 20.5 | 700 | 30 | 30 | 40 | | | |
| 11 | 23.5 | 700 | 30 | 30 | 40 | | | |
| 12 | 25.5 | 700 | 30 | 30 | 40 | | | |
| 13 | 28 | 800 | 20 | 20 | 40 | | | 20 |
| 14 | 30 | 800 | 20 | 20 | 40 | | | 20 |
| 15 | 32 | 800 | 20 | 20 | 40 | | | 20 |
| 16 | 34.5 | 800 | 11 | 13 | 18 | 28 | 12 | 18 |
| 17 | 36.5 | 800 | 11 | 13 | 18 | 28 | 12 | 18 |
| 18 | 38.5 | 800 | 11 | 13 | 18 | 28 | 12 | 18 |

Table 3 gives the % CH₄ conversion, H₂/CO ratio obtained with different catalysts after 600 hours of time on stream (TOS). Commercial and core-shell catalyst possess almost same conversion. H₂/CO ratio in the product gas is in acceptable range and can be varied by varying reaction parameters. Ni/In—CeO₂—MgAl and Ni/Nb—CeO₂—MgAl based catalyst did not show carbon over 1200 hours time on stream. At similar conditions Ni/La—CeO₂—MgAl based and Commercial catalyst showed the presence of coke.

TABLE 3

| Catalyst | GHSV, h⁻¹ | H₂/CO | % CH₄ conversion |
|---|---|---|---|
| Commercial Catalyst | 56000 | 1.86 | 94 |
| Ni—NbCeO₂—MgAl | 56000 | 1.93 | 96 |
| Ni—LaCeO₂—MgAl | 56000 | 1.78 | 86 |
| Ni—InCeO₂—MgAl | 29146 | 1.70 | 85 |

The quality of syngas further tested and compared with commercial and Ni—InCeO₂—Al catalyst at 800° C. and 70,000 h-1 space velocity and the results are given in Table 4. The performance and quality of syngas was found to be better in case core-shell catalyst than commercial catalyst probably because of better metal dispersion and interaction of Ni with CeO₂ due to strong metal-support interaction effects.

TABLE 4

Syngas composition

| | Feed | Commercial | |
|---|---|---|---|
| | conc. | catalyst | Ni—InCeO₂—Al |
| H₂ | 34 | 26.2 | 42.4 |
| CO | 15 | 19.9 | 29.2 |
| CO₂ | 13 | 4.5 | 0.4 |
| Ar | 4 | 22.4 | 18.9 |
| CH₄ | 16 | 13.3 | 4.6 |
| H₂O | 18 | 13.7 | 4.4 |
| H₂/CO | | 1.3 | 1.5 |
| % X(CH₄) | | 16.9 | 71.1 |

### Example 4

### Characterization of Spent Catalysts and Coke Evaluation

Spent catalysts were characterized by powder X-ray diffraction. FIG. 10 shows X-ray diffraction patterns of spent catalysts from the bi-reforming reaction. The dotted line gives the peak for carbon/coke in the catalysts. It is obvious from the diffraction patterns that commercial catalyst and Ni/La—CeO₂—MgAl catalysts contain carbon however; Ni/In—CeO₂—MgAl catalyst is free from any carbon. This is also supported by TPO studies mentioned in earlier section. To ascertain the coke formation, the spent catalysts from bi-reforming reaction were analyzed using temperature programmed oxidation process. The samples were analyzed using TPD Autochem II 2920 instrument supplied by Micromertics. Samples were temperature ramped at 10° C./min in 20% O₂+80% N₂ gas atmosphere. Thermal conductivity analyzer analyzed the difference thermal conductivity that is in present case directly proportional to amount of CO₂+CO formed due to oxidation of coke on the catalysts. As shown in FIG. 10, the commercial spent catalyst showed a peak around 600° C. while Ni deposited on InCeO₂-shell, MgAl₂O₄-core catalyst did not show any peak, which proves that latter is free from any coke demonstrating that the Ni deposited on CeO₂-shell-MgAl₂O₄-core is superior. This is because MgAl₂O₄ is fully covered by CeO₂ and Ni is deposited solely on CeO₂ layer.

Accelerated coking studies were conducted to ascertain the de-coking capacity of the core-shell and commercial catalysts. Two core-shell nature catalysts and one commercial catalyst have been considered and subjected to reformer reaction conditions. The feed composition was H₂=34%, CO=15%, CO₂=13%, Ar=4%, CH₄=16%, H₂O=18%. Initially catalysts were exposed to reformer feed conditions at 800° C. and 1 bar (0.1 MPa) pressure for 300 hours, then the temperature was decreased to 700° C. and reaction was continued. At about 470 h the temperature was further decreased to 600° C. and reactor pressure was monitored. After about 510 h the pressure inside the reactor started to increase as shown in the FIG. 12. The pressure drop is directly proportional to amount of coke formed and restriction caused by coke for gas flow. It is clear from graph in FIG. that commercial catalyst cokes faster than core-shell catalyst. Moreover, Ni/In—CeO₂—MgAl catalyst showed almost negligible amount of pressure drop, however, Ni/La—CeO₂—MgAl did show pressure drop but much lesser than commercial catalyst.

In summary, the catalysts of the present invention based on core-shell structure (example Ni/InCeO₂/Al) showed better performance than Commercial catalysts in all conditions, the H₂/CO ratio was also better for former than latter. Catalyst supported on MgAl₂O₄ (example: Ni/InCe/MgAl₂O₄) possess higher activation i.e., −780° C. temperature than supported on Al₂O₃ example: Ni/InCeO₂/Al₂O₃ activate around 400° C. At higher temperature (>850° C.) the performance of both (Ni/InCeO₂/Al) and (Ni/InCeO₂/MgAl₂O₄) was expected to be same since both catalyst activated below 800° C. Under actual bi-reformer conditions, over 1200° C., coking was observed in the Commercial catalyst, both visually and TPO studies. Coking was not observed in catalyst of the present invention.

1. A method of producing synthesis gas from methane, the method comprising contacting a reactant gas stream that includes hydrogen (H₂), carbon monoxide (CO), carbon dioxide (CO₂), methane (CH₄), and water (H₂O) with a catalyst material under conditions sufficient to produce a gaseous product stream comprising H₂ and CO in a H₂/CO molar ratio of 1.4 to 2.0, wherein the catalyst material comprises:
a chemically inactive metal oxide core;
a redox metal oxide layer deposited on a surface of the metal oxide core, the redox metal oxide layer comprising a dopant; and
a catalytically active metal deposited on the surface of the redox metal oxide layer.

2. The method of claim 1, wherein the reaction conditions include a temperature of 700° C. to 1000° C., a pressure of about 0.1 MPa to 2 MPa, and a gas hourly space velocity of 500 h⁻¹ to 100,000 h⁻¹.

3. The method of claim 1, wherein the reactant stream comprises 25 vol. % to 40 vol. % H₂, 5 vol. % to 30 vol. % CO, 5 vol. % to 20 vol. % CO₂, 10 vol. % to 30 vol. % CH₄, and 10 vol. % to 30 vol. % H₂O.

4. The method of claim 3, wherein the reactant stream comprises 30 vol. % to 35 vol. % H₂, 10 vol. % to 20 vol. % CO, 10 vol. % to 15 vol. % CO₂, 15 vol. % to 20 vol. % CH₄, and 15 vol. % to 20 vol. % H₂O.

5. The method of claim 1, wherein the H₂/CO molar ratio is 1.6 to 2.0, preferably 1.85.

6. The method of claim 1, wherein the conditions comprise contacting the catalyst at a temperature of at least 550° C. with a CO₂ stream comprising at least 50 vol. % CO₂ for at least 6 hours prior to contacting the catalyst with the gaseous reactant stream.

7. The method of claim 6, further comprising replacing a portion of the CO₂ in the CO₂ stream with CH₄, H₂O, CO, and H₂ to produce the gaseous reactant stream.

8. The method of claim 7, wherein replacing a portion of the CO₂ in the CO₂ stream comprises:
introducing CH₄ to the CO₂ stream and contacting the heated catalyst with the CO₂/CH₄ stream at a temperature of at least 600° C. for at least 1 hour;
increasing the concentration of CH₄ in the CO₂/CH₄ stream relative to the amount of CO₂ over time to produce a CO₂/CH₄ stream comprising about equal amounts of CO₂ and CH₄;
introducing H₂O to the CO₂/CH₄ stream at temperature of at least 700° C. to form a CO₂/CH₄/H₂O stream; and
introducing CO and H₂ to the CO₂/CH₄/H₂O stream, forming the gaseous reactant stream comprising H₂, CO, CO₂, CH₄, and H₂O at a temperature of at least 700° C.

9. The method of claim 8, wherein step (b) further comprises increasing the temperature from 600° C. to at least 700° C. at a rate of about 5 to 10° C. per hour.

10. The method of claim 1, wherein coke formation on the catalyst is substantially or completely inhibited.

11. The method of claim 1, wherein the pressure remains constant for at least 600 hours, or at least 1200 hours.

12. The method of claim 1, further comprising providing the product stream to a direct reduced iron unit and reducing iron oxide to iron.

13. The method of claim 1, wherein catalyst has a core/shell structure where the redox-metal oxide layer surrounds the core, and preferably the core is an alumina or alkaline earth metal aluminate core.

14. The method of claim 13, wherein the alkaline earth metal aluminate core is magnesium aluminate, calcium aluminate, strontium aluminate, barium aluminate, or any combination thereof.

15. The method of claim 14, wherein the alkaline earth metal aluminate core is magnesium aluminate, the redox-metal oxide layer is a cerium oxide layer, the metal dopant is niobium (Nb), indium (In), lanthanum (La), gallium (Ga), or any combination thereof, and the active metal is nickel (Ni).

16. The method of claim 1, wherein:
the chemically inactive metal oxide core is alumina or magnesium aluminate;
the redox-metal oxide layer is cerium oxide (CeO₂) and the metal dopant is niobium (Nb), indium (In), lanthanum (La), gallium (Ga), or alloy thereof, or any combination thereof; and
the active metal is nickel.

17. The method of claim 16, wherein chemically inactive metal oxide core contains 65 wt. % to 85 wt. % alumina or magnesium aluminate;
the redox-metal oxide layer contains 10 wt. % to 20 wt. % cerium oxide; and
the nickel is present in an amount of 5 wt. % to 10 wt. %.

18. The method of claim 17, wherein 0.5 wt. % to 2 wt. % of niobium or indium is incorporated into the lattice framework of the cerium oxide layer.

19. The method of claim 1, wherein the redox-metal oxide layer has a thickness of 1 nanometer (nm) to 500 nm, preferably 1 nm to 100 nm, or more preferably 1 nm to 10 nm.

20. A system for direct reduction of iron ore, the system comprising:
a reforming unit capable of producing synthesis gas comprising hydrogen (H₂) and carbon monoxide (CO) in a H₂/CO molar ratio of 1.6 to 2.0 from a gaseous reactant stream comprising H₂, CO, carbon dioxide (CO₂), methane (CH₄), and water (H₂O), the reforming unit comprising:
a reaction zone comprising the gaseous reactant feed and a catalyst material, the catalyst material comprising:
a chemically inactive metal oxide core;
a redox metal oxide layer deposited on a surface of the metal oxide core, the redox metal oxide layer comprising a dopant; and
a catalytically active metal deposited on the surface of the redox metal oxide layer; and
a furnace in fluid communication with the reformer, the furnace capable of reducing iron ore using the synthesis gas received from the reformer.
